(19) United States
(12) Patent Application Publication
(10) Pub. No.: US 2008/0116194 A1
(43) Pub. Date: May 22, 2008

(54) Controller for an Electric Auxiliary Heater for a Motor Vehicle Air-Conditioning System

(75) Inventors: Michel Brun, Rustenhart (FR); Jean-Luc Delamarche, Burnhaupt le bas (FR); Pascal Miss, Selestat (FR); Mathieu Mougey, Ensisheim (FR); Maxime Mundel, Pfaffenheim (FR); Christophe Schmittheisler, Epfig (FR)

Correspondence Address: FOLEY AND LARDNER LLP;SUITE 500, 3000 K STREET NW, WASHINGTON, DC, 20007, US

(73) Assignee: BEHR FRANCE S.A.R.L., Rouffach (FR)

(21) Appl. No.: 11/547,725

(22) PCT Filed: Mar. 17, 2005
(86) PCT No.: PCT/EP05/02818

§ 371 Date: Oct. 29, 2007

(30) Foreign Application Priority Data
Apr. 7, 2004 (EP) 04292945.7

(51) Int. Cl. B60L 1/08; H05B 1/00

(52) U.S. Cl. 219/482; 219/202

(57) ABSTRACT

The invention relates to a controller for an electric auxiliary heater (1) of a motor vehicle air-conditioning system. The controller comprises a power supply cable (2), which provides energy and comprises a control cable for transmitting control signals to a regulator (5) for regulating the auxiliary heater (1). The invention is characterized in that the power supply cable (2) is also the control cable.

The invention relates to a controller for an electric auxiliary heater for a motor vehicle air conditioning system according to the preamble of claim 1 and to a method for operating such a controller.

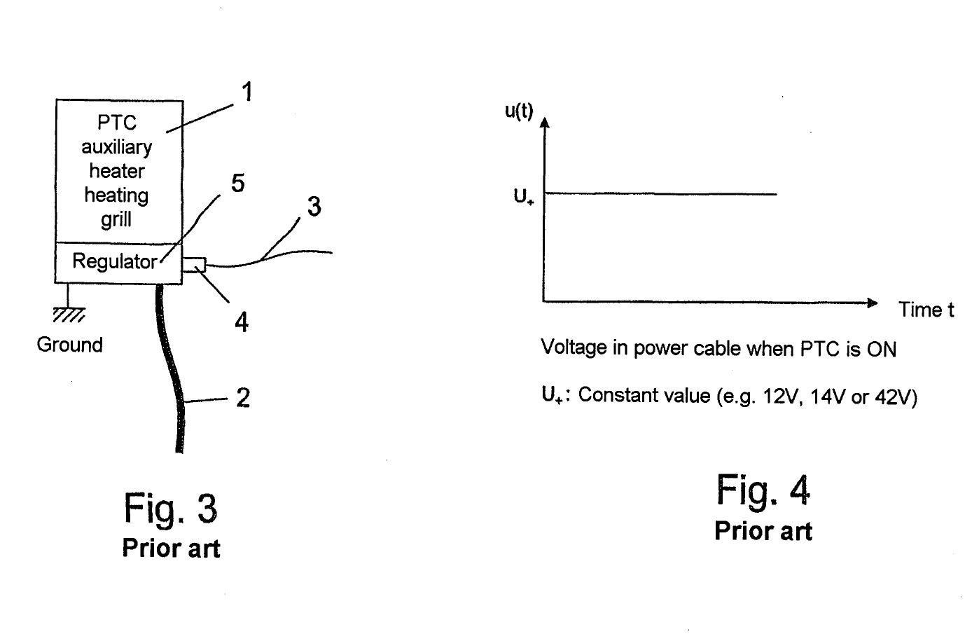

According to the prior art, bus systems which are connected to a corresponding vehicle data network are used to control electrically operated heating devices for motor vehicle air conditioning systems such as, in particular, PTC auxiliary heaters. An example of such a controller and power supply for a PTC auxiliary heater 1 is illustrated in FIGS. 3 and 4. Here, a power supply cable 2 for supplying power to the PTC auxiliary heater 1 which has a heating system, and a control cable 3 with a bus plug 4 for the controller are connected to a regulator 5 of the PTC auxiliary heater 1. The voltage U₊ in the power supply cable 2 remains constant over time t when the auxiliary heater is switched on, apart from the switching on and switching off, as illustrated in the diagram in FIG. 4.

Such a controller leaves room for improvement.

An object of the invention is to improve a controller for an electric auxiliary heater of a motor vehicle air conditioning system of the type mentioned at the beginning.

This object is achieved by means of a controller for an electric auxiliary heater of a motor vehicle air conditioning system having the features of claim 1.

According to the invention, a controller for an electric auxiliary heater for a motor vehicle air conditioning system is provided in which the power supply cable is simultaneously the control cable. As a result, a separately embodied control cable is dispensed with and the requirement for a bus plug for it is eliminated. The separation of the power supply voltage and control signals in the form of changes in voltage is carried out by means of a regulator.

When the auxiliary heater is switched on, the control signals are in the form of voltage changes in the power supply voltage (U₊). If there is no power supply voltage present, only control signals are fed to the regulator.

The control signals preferably have an amplitude with a ratio to the normal power supply voltage without superimposed control signals of less than or equal to 0.1. Such voltage changes can, on the one hand, be detected easily but, on the other hand, they do not significantly affect the function of the auxiliary heater.

The control signals preferably have a rectangular profile over time so that they can be detected easily, but other profiles are also possible.

The electric auxiliary heater is preferably a PTC auxiliary heater but other electric heating devices are also possible.

The unmodulated power supply voltage, that is to say the power supply voltage without control signals, is preferably 12V+/−1V, 14V+/−1V, 24V+/−1V or 42V+/−1V, and therefore corresponds to the normal on-board voltage of a vehicle.

The invention will be explained in detail below by means of an exemplary embodiment and with reference to the drawing, in which:

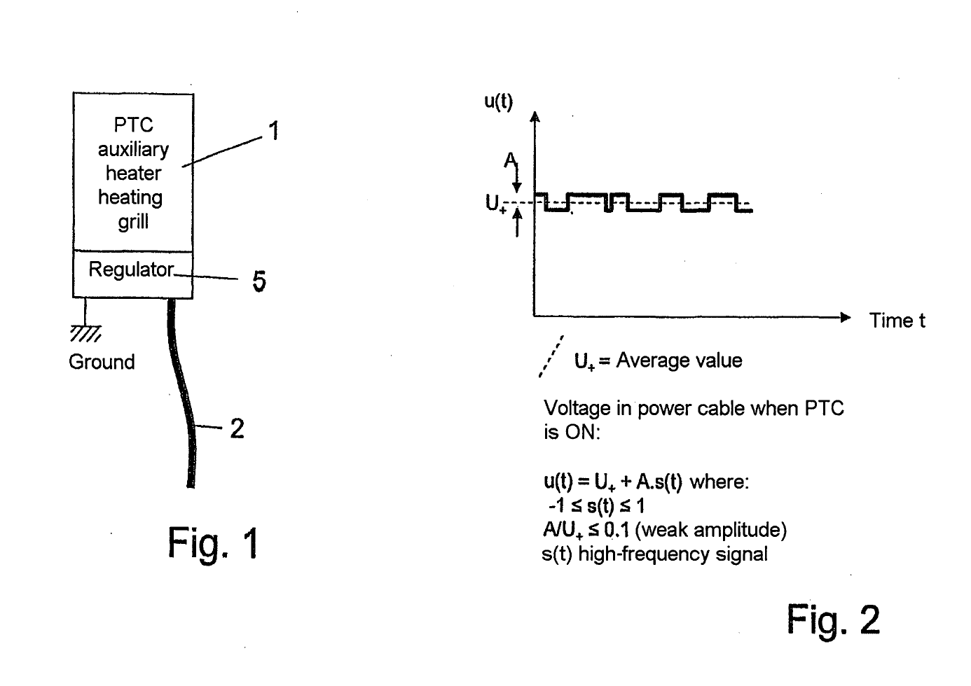

FIG. 1 is a schematic view of a PTC auxiliary heater according to the exemplary embodiment,

FIG. 2 shows the voltage profile in the power supply cable from FIG. 1,

FIG. 3 shows a schematic view of a PTC auxiliary heater according to the prior art, and

FIG. 4 shows the voltage profile in the power supply cable from FIG. 3 according to the prior art.

FIG. 1 shows, as an electric auxiliary heater of a motor vehicle air conditioning system, a PTC auxiliary heater 1 with a power supply cable 2 for supplying power to the PTC auxiliary heater 1 which has a heating grill for generating heat. The power supply cable 2 applies a voltage U₊ of 12V to the PTC auxiliary heater 1 when necessary.

In order to control the PTC auxiliary heater 1, a regulator 5, to which the power supply cable 2 is led, is provided. Control signals in the form of square-wave voltage modulations, voltage changes with an amplitude A, are also transmitted via the power supply cable 2, superimposed on the voltage U₊, that is to say the power supply cable 2 serves simultaneously as a control cable. Here, the ratio of the amplitude A to the power supply voltage U₊ is 0.1. The control signals are transmitted as high-frequency signals. FIG. 2 illustrates the state when the PTC auxiliary heater 1 is connected.

### List of Reference Symbols

1 PTC auxiliary heater

2 Power supply cable

3 Control cable

4 Bus connector

5 Regulator

A Amplitude

t Time

U₊ Voltage

1. A controller for an electric auxiliary heater for a motor vehicle air conditioning system, having a power supply cable which provides energy, and a control cable which transmits control signals to a regulator for regulating the auxiliary heater, wherein the power supply cable is simultaneously the control cable.

2. The controller as claimed in claim 1, wherein the power supply cable is connected to a regulator.

3. The controller as claimed in claim 1, wherein the control signals are in the form of voltage changes in the power supply voltage (U₊).

4. The controller as claimed in claim 3, wherein the control signals have an amplitude (A) with a ratio to the normal power supply voltage (U₊) without superimposed control signals of less than or equal to 0.1.

5. The controller as claimed in claim 1, wherein the control signals have a rectangular profile over the time (t).

6. The controller as claimed in claim 1, wherein the electric auxiliary heater is a PTC auxiliary heater.

7. The controller as claimed in claim 1, wherein the power supply voltage (U₊) without control signals is 12V+/−1V, 14V+/−1V, 24V+/−1V or 42V+/−1V.

8. A method for operating a controller for an electric auxiliary heater for a motor vehicle air conditioning system, wherein the control signals are transmitted via the power supply cable by superimposing them on the power supply voltage (U₊).
